(19) United States
(12) Patent Application Publication
(10) Pub. No.: US 2022/0176661 A1
(43) Pub. Date: Jun. 9, 2022

(54) METHOD FOR MANUFACTURING AN AUTOSTEREOSCOPIC SCREEN AND METHOD FOR CONVERTING FROM A SCREEN FOR DISPLAYING A TWO-DIMENSIONAL IMAGE TO A SCREEN FOR DISPLAYING AN AUTOSTEREOSCOPIC IMAGE

(71) Applicant: ALIOSCOPY, Paris (FR)

(72) Inventor: Pierre ALLIO, Paris (FR)

(21) Appl. No.: 17/437,040

(22) PCT Filed: Feb. 27, 2020
(86) PCT No.: PCT/FR2020/050388

§ 371 Date: Sep. 7, 2021

(30) Foreign Application Priority Data
Mar. 4, 2019 (FR) 1902205

(51) Int. Cl. B29D 11/00; G02B 30/27; G02B 3/00

(52) U.S. Cl. CPC B29D 11/00298; B29D 11/00644; G02B 3/0012; G02B 30/27; B29D 11/00442

(57) ABSTRACT

The invention relates to a manufacturing method for a screen for displaying an autostereoscopic image, including the steps of: selecting (E10) a block of pixels which are arranged in rows and columns, each pixel being composed of a plurality of sub-pixels of different colors; selecting (E11) a polarization film; manufacturing (E12, E13, E14) a lenticular array directly on the polarization film in order to form a composite film, called optical film; bonding (E15) the optical film to the block of pixels. The invention also relates to a method for converting a screen for displaying a two-dimensional image into a screen for autostereoscopic display.

### TECHNICAL FIELD OF THE INVENTION

The invention relates to the field of autostereoscopy, and more particularly to the manufacture of an autostereoscopic screen and the conversion of a screen for displaying a two-dimensional image to a screen for displaying an autostereoscopic image.

### TECHNICAL BACKGROUND

Autostereoscopy is a technique that enables images to be displayed in relief without requiring the observer to wear special eyewear. This technique itself constitutes prior knowledge, with reference in particular to patent documents WO2006/024764, WO2014/041504, WO2013/140363 and WO2014/016768 registered applicant's name.

Generally speaking, an autostereoscopic image consists of multiple elementary image bands interlaced according to a predetermined mixing scheme, corresponding to images of the same object or of the same scene from different points of view. A selector device, typically constituting an array of cylindrical lenticular lenses or a parallax barrier, is arranged in front of the display screen so as to allow the projection of a pair of elementary images corresponding to two different points of view of a single scene toward each of the two eyes of the observer, which creates an impression of relief in the brain of the observer.

The applicant has already proposed an autostereoscopic screen comprising a pixel matrix arranged in rows and columns, each pixel being composed of multiple sub-pixels of different colors. The screen is additionally overlaid with an array of identical cylindrical lenticular lenses each having a focal length configured such that it returns the light rays coming from the screen an infinite number of times. The width of the lenses is approximately equal to the width of N sub-pixels, N being the number of points of view (since the applicant advises the use of a single sub-pixel per point of view per lens and per horizontal line instead of one pixel). However, other configurations are possible without this substantially modifying the effect achieved. The spacing of the cylindrical lenticular array is precisely calculated so that the observer sees, at a predetermined distance from the screen (called the flat tint distance, which is for example fixed at 85 cm), the images shift in succession 6.5 cm (average distance between the eyes, chosen as the basis of calculation), due to the magnifying effect of the lenticular array.

This magnifying effect results from the fact that a lens placed at the right distance (its focal length) magnifies the sub-pixel which is in alignment with its optical axis and the pupil of the eye of the observer. If the lens is magnified N times, the sub-pixel seen through the lens is perceived N times wider than it is and obscures from the eye that receives the light through this lens the other N−1 sub-pixels that are not in the alignment described above.

Thus, the observer only perceives one Nth of the resolution of the screen with each eye. When associated with one another, these points form an image or a point of view, and are all magnified N times horizontally. N−1/Nₜₕ of the resolution remains to present the N−1 other points of view according to the same method.

One of the difficulties encountered in producing an autostereoscopic screen lies in the step of positioning and bonding the optical component on the front surface of the screen. Indeed, this optical component must be bonded at a precise distance from the surface of the screen to allow the magnifying effect described above. In particular, the thicknesses optically crossed up to the effective surface of the pixels must correspond, in total and taking into account the refractive indices of each of the materials crossed, including air, to the focal length of the microlenses of the lenticular array.

The profile of the microlenses, which is most often cylindrical, can be radiated. Certain optical components, with a prismatic profile, correspond to the chords, in a number equal to the desired number of points of view, of the circular arc of the same radius as in the case of microlenses with a cylindrical profile.

For some screens, the focal length of the lenses corresponds to the optical thickness to be crossed to reach the pixels of the screen. Therefore, the lenses must be mounted facing the screen, in contact with the latter.

The difficulty is then in positioning the lenticular array so that the tops of the lenses are in contact with the screen while minimizing the appearance of Newton's rings (interference pattern formed by a series of concentric rings or bands in relation with the geometry of the contact zones, alternately bright, dark and colored, centered on the point of contact between the spherical or cylindrical surface of the lens and the flat surface of the screen). When the screen is off, the surface appears to be streaked with dark and sometimes colored areas alternating with grayer lines in step with the lenses. This phenomenon evolves and becomes more pronounced over time.

The inventors have therefore sought to improve the methods currently available for manufacturing autostereoscopic screens, in particular when the cylindrical lenses must be bonded as close as possible to the screen.

In particular, the inventors have sought to develop a manufacturing method which makes it possible to obtain a screen which is stable over time.

### AIMS OF THE INVENTION

The invention therefore aims to provide a method of manufacturing an autostereoscopic screen which addresses at least some of the drawbacks of the known solutions.

The invention aims in particular to provide, in at least one embodiment, a method of manufacturing an autostereoscopic screen which is simplified compared to the methods currently implemented to manufacture an autostereoscopic screen.

The invention also aims to provide, in at least one embodiment, a method of manufacturing an autostereoscopic screen which makes it possible to obtain a screen that remains stable over time.

The invention also aims to provide, in at least one embodiment, a method of manufacturing an autostereoscopic screen which makes it possible to obtain a screen which has an improved appearance, whether it is turned on or off.

The invention also aims to provide a method of converting a screen for displaying a two-dimensional image to a screen for displaying an autostereoscopic image.

The invention also aims to provide, in at least one embodiment, a method which can be implemented by manufacturers of standard screens without substantial modification of the manufacturing method.

### DESCRIPTION OF THE INVENTION

To do this, the invention relates to a method for manufacturing a screen for displaying an autostereoscopic image, comprising the steps of:
selecting a block of pixels which are arranged in rows and columns, each pixel being composed of a plurality of sub-pixels of different colors,
selecting a polarization film having a first optical axis,
manufacturing a lenticular array directly on said selected polarization film in order to form a composite film, called an optical film, said lenticular array having a second optical axis,
bonding said optical film directly to said selected block of pixels so as to obtain a polarizing and lenticular display screen having two optical axes associated respectively with a polarization function and an autostereoscopic function.

A method according to the invention therefore makes it possible to manufacture the lenticular array directly on the surface of the screen by means of a polarization film, also referred to as a polarizer film.

A method according to the invention therefore makes it possible to simplify the manufacture of an autostereoscopic screen by eliminating the step of fixing a previously designed lenticular array on the surface of a screen and by replacing this step with a step of manufacturing the array directly on a polarization film.

A method according to the invention therefore makes it possible to benefit from all the experience acquired by manufacturers of 2D screens, in particular as regards the manufacture and application of polarization films, to manufacture autostereoscopic screens. The formed optical film does not alter the mechanical properties of the polarization film, or the stability of the composite film over time. A manufacturing method according to the invention therefore makes it possible to provide autostereoscopic screens that are stable over time.

In addition, a method according to the invention eliminates the risks of seeing Newton's rings appear when the lenses of the array must be in contact with the surface of the screen. A method according to the invention therefore makes it possible to improve the appearance of the manufactured screens with respect to known screens, both when they are on and when they are off.

A method according to the invention also makes it possible to confer a dual function on the optical film, namely a polarization function and an optical component function allowing the formation of an autostereoscopic image. Thus, laying an optical film according to the invention on a block of pixels makes it possible to confer both the polarization properties and the autostereoscopic properties on the screen.

The optical film obtained during the method according to the invention is characterized in that it has at least two optical axes associated with two different functions: the polarization axis and the axis of the microlenses of the lenticular array formed by the method according to the invention.

Advantageously and according to the invention, said step of manufacturing a lenticular array directly on said polarization film includes sub-steps consisting in:
applying a layer of transparent polymerizable resin over said polarization film,
implanting said lenticular array in said layer of polymerizable resin,
polymerizing said polymerizable resin so as to obtain a transparent and stable composite film incorporating said lenticular array.

A method according to this variant is particularly simple to implement insofar as it consists in applying a layer of polymerizable resin on the polarization film and in shaping it while it is fluid by printing, engraving after hardening, screen printing or any equivalent means for directly obtaining the targeted lenticular array after polymerization of said resin.

The polymerization of the resin can be obtained by curing by UV light, by chemical hardener or by heat application during the molding operations, or by any equivalent means.

The adhesion of this resin fixed to the polarization film can be improved by any type of means, such as, for example, a corona treatment, the use of an adhesion primer, the use of solvents, a plasma with atmospheric pressure, or even a vacuum plasma.

A method according to this variant makes it possible to form any type of lenticular array on the composite film, and in particular a radiated array or a faceted array.

In addition, a method according to this variant makes it possible to manufacture any type of array in a simple manner, whatever the desired angle of inclination of the lenses with respect to the direction of the columns of the block of pixels.

According to an advantageous variant of the invention, said transparent polymerizable resin is a resin (one-component or two-component), polymerizable by UV or by chemical reaction resulting from a mixture with another component, or by the addition of heat.

In the case of a transparent UV resin, the polymerization is advantageously carried out through the polarization film, by means of a lamp emitting both in the UV and in the visible domain.

The step consisting in implanting said lenticular array in said resin layer may consist in implementing one of the following steps:
laminating said polarization film with a cylinder engraved with the shapes and dimensions of the desired lenticular array,
printing said polarization film by means of a UV varnish printer a pattern in the shapes and dimensions of the desired lenticular array,
screen printing said polarization film in the shapes and dimensions of the desired lenticular array,
applying a mold to said polarization film having the shapes and dimensions of the desired lenticular array.

Of course, other means can be used to form the lenticular array in the resin layer affixed on the polarization film.

Advantageously and according to the invention, said selected polarization film is formed from a film of polyvinyl oxide stretched and laminated between two films of cellulose triacetate.

According to this variant, it is also possible to modify the surface of the cellulose triacetate film directly by the lenticular array.

The invention also relates to a method of converting a screen for displaying a two-dimensional image, called a 2D screen, to a screen for displaying an autostereoscopic image, called a 3D screen, said 2D screen comprising at least one layer of liquid crystals forming a block of pixels, overlaid at least by a polarization film, said method comprising the steps of:
removing said polarization film from said 2D screen,
selecting a polarization film,
manufacturing a lenticular array directly on said selected polarization film in order to form a film, called an optical film,
bonding said optical film directly to said block of pixels of said 2D screen.

A method according to the invention therefore makes it possible to use a standard screen dedicated to displaying a 2D image and to convert it into a screen dedicated to displaying an autostereoscopic image. This conversion consists in removing the polarization film and replacing it with a polarization film on which a lenticular array is implanted using a manufacturing method according to the invention.

Therefore, the advantages of a method for manufacturing a screen for displaying an autostereoscopic image according to the invention apply mutatis mutandis to a method for converting a screen according to the invention.

A method according to the invention makes it possible to manufacture, in a simplified and repetitive manner, stable autostereoscopic screens which can be used in various applications, and in particular in automotive, medical, aeronautical, telephone, etc. applications.

Advantageously and according to the invention, said step of manufacturing a lenticular array directly on said polarization film includes sub-steps consisting in:
applying a layer of transparent polymerizable resin over said polarization film,
implanting said lenticular array in said layer of polymerizable resin,
polymerizing said polymerizable resin so as to obtain a transparent and stable composite film incorporating said lenticular array.

The invention also relates to a method for manufacturing a screen for displaying an autostereoscopic image and a method for converting a display screen characterized in combination by all or part of the features mentioned above or below.

### LIST OF FIGURES

Further aims, features and advantages of the invention will become apparent upon reading the following description, which is provided solely by way of non-limiting example, and which refers to the accompanying figures, in which:

FIG. 1 is a synoptic schematic view of a method according to one embodiment of the invention.

FIG. 2 is a schematic view of a device making it possible to implement the step of implanting a lenticular array on a polarization film of a method according to one embodiment of the invention.

### DETAILED DESCRIPTION OF ONE EMBODIMENT OF THE INVENTION

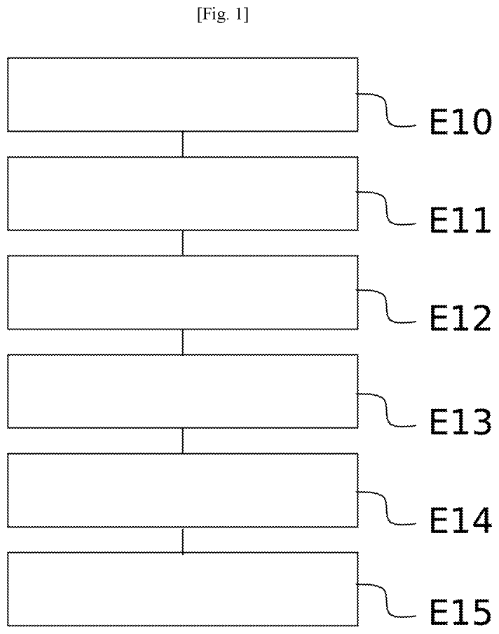

As shown in FIG. 1, a method according to a preferred embodiment comprises a step E10 for selecting a block of pixels, a step E11 for selecting a polarization film, a step E12 for applying a layer of polymerizable resin directly to the selected polarization film, a step E13 for implanting a lenticular array in the resin layer deposited on the polarization film, a step E14 for polymerizing the resin so as to obtain a transparent and stable composite film integrating the lenticular array and a step E15 for bonding the composite film thus formed on the selected block of pixels.

At least one embodiment of each of these steps will now be described in detail.

Step E10 for selecting a block of pixels consists in choosing a block of pixels with dimensions that are compatible with the targeted application. Such a block of pixels can be of any known type. The block comprises pixels arranged by rows and by columns and each pixel is composed of a plurality of sub-pixels of different colors.

Step E11 for selecting a polarization film consists in choosing a polarization film, with dimensions compatible with the selected block of pixels.

In the case of a method for converting a 2D screen into a 3D screen, steps E10 and E11 consist in peeling the polarization film off of the considered 2D screen and in selecting the block from the 2D screen to be converted as the block of pixels.

It is also possible to bond a transparent film to this polarization film in order to form a new polarization film which is then treated by the method according to the invention. It is also possible to manufacture the lenticular array directly onto a transparent film and then to bond it directly on a polarizer which is not bonded to the screen. This variant thus makes it possible to obtain a new composite film which is bonded to a screen which no longer has a polarizer, or to a screen which is already equipped with a polarizer, thus doubling the thickness of the initial polarizer by adding the thickness and the function of the additional transparent lenticular film to it. This may in particular be necessary if the lenticular array to be implanted on the polarization film must not be in direct contact with the original polarization film, but slightly spaced apart from the latter, in particular given the optical focal length requirements.

It is also possible to adapt a method of converting a 2D screen into a 3D screen according to the invention by forming a lenticular array on a transparent film, instead of forming it on a polarization film, and bonding this lenticular array thus formed directly on the surface of the 2D screen from which the original polarization film has been removed. The conversion method then consists in bonding the polarization film previously peeled off of the 2D screen or another polarization film, mounted on a rigid substrate, on the lenticular array bonded to the block of pixels of the 2D screen.

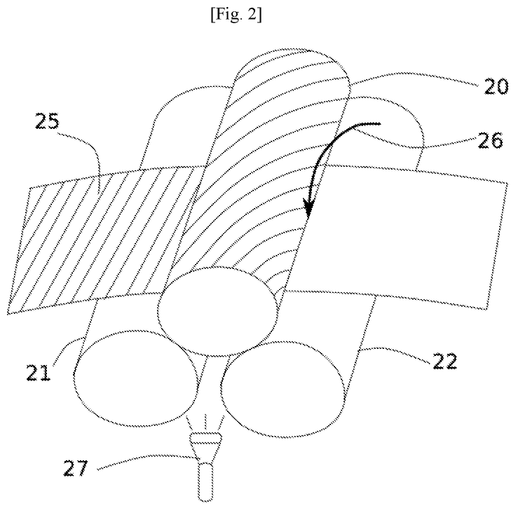

According to one embodiment of the invention, step E12 for applying a resin layer on the polarization film, step E13 for implanting a lenticular array on said polarization film and step E14 for polymerizing the resin on the polarization film are interwoven and carried out in a coordinated manner. This step can for example be implemented by the device shown schematically in FIG. 2.

To do this, an engraved metal cylinder 20 (having a polished glass surface state and grooves with shapes and dimensions conforming exactly to the lenses of the lenticular array to be produced) is placed on a platform consisting of two rollers 21, 22, for example made from rubber, which each extend in the same direction. The axes of the two rollers are therefore parallel. Each roller 21, 22 is driven in rotation by an electric motor, not shown in FIG. 2 (of course, any other means for driving each of the rollers in rotation is possible to achieve a substantially identical result). According to another variant described later, only one rubber roller is motorized.

The rollers 21, 22 are spaced apart from one another in the direction perpendicular to the direction of their axis of rotation, so as to allow the passage of UV light or visible light, but close enough to retain the engraved metal cylinder 20, which is placed on the two rollers.

The selected polarization film 25 (or the polarization film peeled off of the 2D screen in the case of a conversion of a 2D screen into a 3D screen) is conveyed between the two rubber rollers 21, 22 and the engraved cylinder 20. In other words, the polarization film 25 is sandwiched between the two rubber rollers from below, and the engraved metal cylinder from above.

The polarization film is held stretched, to keep it tangent to the two rubber rollers and the engraved metal cylinder. This tensioning action of the polarization film can be obtained by any type of means.

The UV resin is then deposited in contact with the metal cylinder on the surface of the polarization film, upstream of this cylinder. The arrow 26 schematically shows the pouring of the resin upstream of the cylinder. The upstream side of the cylinder is defined by the direction of rotation of the cylinder and of the advance of the polarization film (from right to left in the illustration of FIG. 2). In other words, the resin is deposited just before the film 25 passes under the cylinder 20. This displacement of the polarization film in a direction, called the direction of advance, perpendicular to the axis of rotation of the rubber rollers and of the engraved cylinder is obtained by friction of the film between the rubber rollers and the engraved cylinder.

The synchronized rotation of the two rubber rollers 21, 22, the engraved cylinder 20, and the movement of the polarization film 25 along the direction of advance forces the resin to pass under the engraved cylindrical roller 20.

According to a variant of the invention, only one rubber roller is motorized and drives the engraved film, the engraved cylinder and the other rubber roller by friction.

When the resin passes under the metal cylinder between the latter and the film stretched on its surface, said resin polymerizes and freezes due to the flow of UV light and/or visible light that it receives between the rubber rollers, which together form a diaphragm.

Depending on the resin used, it may be necessary to treat the surface of the engraved cylinder to ensure that the resin adheres better to the polarization film than to the metal cylinder so that the film carries the cured resin as it exits between the engraved cylinder and the rubber rollers.

The polarization film 25 thus obtained has, on its surface, the negative of the engravings of the cylinder 20, made of transparent material, forming a lenticular array which perfectly conforms in pitch and focal length to the targeted lenticular array.

Thus and as schematically shown in FIG. 2, the polarization film 25 at the outlet of the device (on the left in the figure) has a lenticular array on the surface of the film, while the surface of the film upstream of the device has no array.

The emission of UV and/or visible light 27 can be obtained by any known means. The method can nevertheless be facilitated by preventing an increase in temperature during the various stages of the described method leading to geometric alterations of the metal cylinder and/or of the polarization film. Therefore, an infrared filter and ventilation can advantageously be implemented during the implantation operations of the lenticular array to avoid such a temperature increase and thus to improve the results of the method according to this embodiment, in particular.

Finally, the last step, E15, which bonds the composite film thus formed on the selected block of pixels, can be carried out by any known means. In particular, this bonding step can be implemented by the same means as the step of bonding a conventional polarization film onto a standard 2D block of pixels. This is, in particular, one of the advantages of a method according to the invention, which can be integrated without particular difficulties into a 2D screen manufacturing method by simply modifying the step of manufacturing the polarization film, in order to design autostereoscopic screens, thus substantially reducing the manufacturing costs of such screens.

The described method is only one embodiment of the invention. It is also possible to carry out the invention by replacing the use of an engraved metal cylinder with the implementation of a UV varnish printer directly onto the polarization film to form the desired lenticular array. It is also possible to screen print said polarization film with the shapes and dimensions of the desired lenticular array. It is also possible to apply a mold to the polarization film, this mold being in the same shape and dimensions of the desired lenticular array.

According to another embodiment, it is also possible to produce the lenticular array with a UV resin which has a relatively high refractive index with a lens profile corresponding to a focal length which is much shorter than the desired one. It is then possible to modify the focal length by embedding the first lenticular array with a resin of much lower refractive index in order to compensate for the modification of the voluntarily chosen radius of curvature. The advantage of such a method lies in the fact that, in the latter case, the active diopter is embedded in the heart of a device integrating two transparent components with two different indices. In this case, the lenticular array can be completely included between two flat surfaces. On one side, the screen surface, and on the other, a glass or plastic plate acting as a protective and finishing plate, either slightly frosted or anti-reflective or the like.

1. A method for manufacturing a screen for displaying an autostereoscopic image, comprising the steps of:
selecting a block of pixels which are arranged in rows and by columns, each pixel being composed of a plurality of sub-pixels of different colors,
selecting a polarization film having a first optical axis,
manufacturing a lenticular array directly on said selected polarization film to form a composite film, called optical film, said lenticular array having a second optical axis, and
bonding said optical film on said selected block of pixels so as to obtain a polarizing and lenticular display screen having two optical axes associated respectively with a polarization function and an autostereoscopic function.

2. The method according to claim 1, wherein said step for manufacturing a lenticular array directly on said polarization film comprises:
applying a layer of transparent polymerizable resin on said polarization film,
implanting said lenticular array in said layer of polymerizable resin, and
polymerizing said polymerizable resin so as to obtain a transparent and stable composite film integrating said lenticular array.

3. The method according to claim 2, wherein said transparent polymerizable resin is a resin, (one-component or two-component), polymerizable by UV or by chemical reaction following mixing with another component, or by the addition of heat.

4. The method according to claim 2, wherein said step consisting in implanting said lenticular array in said polymerizable resin layer consists in laminating said polarization film with a cylinder engraved with the shapes and dimensions of the desired lenticular array.

5. The method according to claim 2, wherein said step consisting in implanting said lenticular array in said polymerizable resin layer consists in printing said polarization film by means of a UV varnish printer a pattern in the shapes and dimensions of the desired lenticular array.

6. The method according to claim 2, wherein said step consisting in implanting said lenticular array in said polymerizable resin layer consists in screen printing said polarization film in the shapes and dimensions of the desired lenticular array.

7. The method according to claim 2, wherein said step consisting in implanting said lenticular array in said polymerizable resin layer consists in applying a mold on said polarization film in the shapes and dimensions of the desired lenticular array.

8. The method according to claim 2, wherein said selected polarization film is formed from a film of polyvinyl oxide stretched and laminated between two films of cellulose triacetate.

9. A method for converting a 2D screen for displaying a two-dimensional image into a 3D screen for displaying an autostereoscopic image, said 2D screen comprising at least one layer of liquid crystals forming a block of pixels, overlaid at least by a polarization film, said method comprising the steps of:
peeling said polarization film off of said 2D screen,
selecting a polarization film,
manufacturing a lenticular array directly on said selected polarization film to form a film, called optical film, and
bonding said optical film directly onto said block of pixels of said 2D screen.

10. The method according to claim 9, wherein said step for manufacturing a lenticular array directly on said polarization film comprises the:
applying a layer of transparent polymerizable resin on said polarization film,
implanting said lenticular array in said layer of polymerizable resin, and
polymerizing said polymerizable resin so as to obtain a transparent and stable composite film integrating said lenticular array.

11. A method for manufacturing a lenticular array on a polarization film, comprising:
applying a layer of transparent polymerizable resin on said polarization film,
implanting said lenticular array in said layer of polymerizable resin, and
polymerizing said polymerizable resin so as to obtain a transparent and stable composite film integrating said lenticular array.
